(19) United States
(12) Patent Application Publication
(10) Pub. No.: US 2005/0072634 A1
(43) Pub. Date: Apr. 7, 2005

(54) Lubrication system for a patty-forming apparatus

(76) Inventors: James E. Pasek, Tinley Park, IL (US); Salvatore Lamartino, Orland Park, IL (US); David Hansen, Orland Park, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 10/942,744

(22) Filed: Sep. 16, 2004

Related U.S. Application Data
(60) Provisional application No. 60/503,354, filed on Sep. 16, 2003.
(60) Provisional application No. 60/515,585, filed on Oct. 29, 2003.
(60) Provisional application No. 60/571,368, filed on May 14, 2004.
(60) Provisional application No. 60/571,354, filed on May 14, 2004.

(51) Int. Cl. F16N 1/00

(52) U.S. Cl. 184/5

(57) ABSTRACT

A lubrication system is provided for a reciprocating mold plate patty-forming apparatus. The lubrication system includes a plurality of oil fed bearings, two bearings journaling each mold plate drive rod. A substantially sealed oil containing compartment is provided for a rotary member that drives the patty knockout mechanism. The rotary member is arranged within the oil containing compartment. The rotary member is at least partly submerged beneath a level of lubricating oil within the compartment. Two tube valve bushings are provided for journaling rotary movement of a tube valve that selects between two food pumps that deliver pressurized food product to the mold plate. Each of the tube valve bushings has provisions for being greased. The tube valve bushings journal opposite ends of the tube valve. The tube valve bushings are preferably mounted externally to opposite sides of the manifold.

The application claims the benefit of provisional application Ser. No. 60/571,368 filed May 14, 2004; U.S. provisional application Ser. No. 60/503,354, filed Sep. 16, 2003; and U.S. provisional application Ser. No. 60/515,585, filed Oct. 29, 2003.

### BACKGROUND OF THE INVENTION

Use of pre-processed foods, both in homes and in restaurants, has created a demand for high-capacity automated food processing equipment. That demand is particularly evident with respect to hamburgers, molded steaks, fish cakes, and other molded food patties.

Food processors utilize high-speed molding machines, such as FORMAX F-6, F-12, F-19, F-26 or F-400 reciprocating mold plate forming machines, available from Formax, Inc. of Mokena, Ill., U.S.A., for supplying patties to the fast food industry. Prior known high-speed molding machines are also described for example in U.S. Pat. Nos. 3,887,964; 4,372,008; 4,356,595; 4,821,376; and 4,996,743 herein incorporated by reference.

Although heretofore known FORMAX patty-molding machines have achieved commercial success and wide industry acceptance, the present inventors have recognized that needs exist for a forming machine having an even greater energy efficiency, an even greater durability and an even greater duration of maintenance free operation. The present inventors have recognized that needs exist for a smoother and quieter patty-forming machine operation.

### SUMMARY OF THE INVENTION

The invention provides a lubrication system for a patty-forming apparatus of the kind having a reciprocating mold plate driven by parallel drive rods from a cavity fill position to a patty discharge position, and two food product pumps alternatively operable to supply food product to the mold plate. The food product pumps are selected to communicate food product to the mold plate by a rotatable tube valve. A knockout mechanism includes knockout plungers that are reciprocal between a stand by position and a deployed position to displace patties from the mold plate. The knockout mechanism includes a rotary member that converts rotation input to reciprocation of the knockout plungers.

According to one aspect of the invention, the lubrication system includes a plurality of bearings, at least one bearing journaling each drive rod. The bearings each have a lubrication oil channel therein. A lubrication oil reservoir is connected by a conduit to the lubrication oil channels. A pump is arranged to deliver oil from the reservoir through the conduit and through the channels to lubricate sliding movement of the rods through the bearings. The mold plate drive mechanism, being so lubricated, runs smoother, quieter, with greater energy efficiency and with greater durability.

According to another aspect of the invention, a substantially sealed oil containing compartment is provided for the knockout mechanism. The rotary member is arranged within the oil containing compartment. The rotary member is at least partly submerged beneath a level of lubricating oil within the compartment. The knockout mechanism includes a crank rod pivotally connected to the rotary member within the compartment. The crank rod is also pivotally connected to a knockout frame which drives one or more knockout rods which drive the knockout plungers. The pivotal connections between the rotary member, the crank rod and the frame are all located within the compartment and are all lubricated by oil within the compartment. The knockout mechanism, being so lubricated, runs smoother, quieter, with greater energy efficiency, and with greater durability.

According to another aspect of the invention, at least one tube valve bushing is provided for journaling rotary movement of the tube valve. The tube valve bushing has a channel therein for being filled with lubricating material. Preferably, the tube valve is fit within a manifold that directs food product from the food product pumps to the mold plate, and the tube valve bushing is externally mounted to the manifold.

Preferably, the at least one tube valve bushing comprises two tube valve bushings. Each of the tube valve bushings has the channel therein arranged for being filled with lubricating material. The tube valve bushings journal opposite ends of the tube valve. The tube valve bushings are preferably mounted externally to opposite sides of the manifold. Because the tube valve is journaled with externally mounted bushings, rather than being journaled by the valve manifold itself, wear on the manifold is eliminated. The bushings can be replaced or repaired at significantly less cost than a similar repair to, or replacement of, the valve manifold.

The preferred embodiment of the invention comprises a high-speed food patty molding machine that includes a molding mechanism having an inlet for receiving a moldable food material. The machine further comprises two food pumps, each pump including a pump cavity having an intake opening and an outlet opening, a plunger aligned with the cavity, and drives for moving the plunger between a retracted position clear of the intake opening in the cavity, and a pressure position in which the plunger is advanced inwardly of the cavity, beyond the intake opening, toward the outlet opening. Supply means are provided for supplying moldable food material to the intake opening of each pump cavity whenever the plunger for that pump is in its retracted position. A valve manifold connects the outlet openings of the two pump cavities to the inlet of the molding mechanism. Actuating means are provided to actuate the pumps in that at least one pump cavity always contains moldable food material under pressure.

The molding mechanism comprises a reciprocating mold plate having one or more rows of mold cavities that are filled via the inlet of the molding mechanism. The mold plate is reciprocated by a servo-drive that can precisely control the position of the mold plate, and the movement of the mold plate. Thus, the mold plate speed, acceleration, deceleration and dwell periods for filling and/or for discharging the cavities can be precisely controlled. These movements and dwell period can be tailored according to the type of food material and to the shape of the patties.

According to the invention, the servo-drive reciprocates longitudinally arranged mold plate drive rods that are operatively connected to the mold plate. The drive rods are guided by sleeve bearings. The apparatus includes a bearing lubrication oil circulation system for lubricating the sleeve bearings. The system includes a lubrication oil pump and oil reservoir. The lubrication oil pump circulates lubrication oil through sleeve bearings located at both the front and rear of each of the drive rods. The sleeve bearings include helical lubrication grooves that distribute the lubrication oil around the entire circumference of each drive rod. The lubrication oil is filtered before being returned to the reservoir.

The mold mechanism also includes a servo driven knockout mechanism wherein the speed, acceleration, deceleration and dwell periods of the knockout plungers can also be precisely controlled to be synchronized with the mold plate movements and positions, and for the type of food product and shape of the patties. According to the invention, the knockout mechanism includes a rotating eccentric that is submerged in a lubricating oil bath and includes provisions on the eccentric to sling oil to upper portions of the knockout housing. Also, a controlled knockout rod bearing lubrication system is employed to periodically lubricate the knockout rods.

A tube valve is fit into the valve manifold to seal between the outlet opening of each pump cavity and the manifold whenever the plunger for that pump is moved toward its retracted position, thereby supporting a continuous supply of moldable food material, under pressure, to the inlet of the molding mechanism.

According to the invention, the apparatus includes an improved tube valve mounting assembly. The tube valve mounting assembly includes inboard and outboard bearings or bushings located externally on opposite lateral sides of the valve manifold that are removably fastened to the outside of the valve manifold. The bushings include an internal grease groove fed by a grease fitting. Thus, the bushings can be periodically greased. A first O-ring seal is provided inside the valve manifold which is sealed via the insertion of the lead end of the tube valve that is inserted into the manifold during assembly. A second O-ring seal is applied to a trailing end of the tube valve for sealing against an inside surface of the valve manifold.

The present invention provides an improved automated food patty molding machine capable of producing uniform molded food patties at a high rate of production. The invention also provides an improved high-speed food patty molding machine that is inherently subject to only minimal wear in operation, and that requires no more than minimal maintenance. The invention also provides an improved high-speed patty molding machine that is inherently quiet in operation. The invention also provides an improved patty molding machine that has and enhanced energy efficiency. The invention also provides an improved high-speed food patty molding machine that is simple and cost effectively manufactured, assembled, and repaired.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a perspective view of a patty-forming machine of the present invention;

FIG. 1A is an elevational view of the patty-forming machine of FIG. 1;

FIG. 2 is a longitudinal sectional view of the patty-forming machine of FIG. 1, with some components and/or panels not shown, or broken away, for clarity;

FIG. 3 is a sectional view taken generally along line 3-3 of FIG. 2, with some components and/or panels not shown, or broken away, for clarity;

FIG. 4 is a sectional view taken generally along line 4-4 of FIG. 2, with some components and/or panels not shown, or broken away, for clarity;

FIG. 5 is a sectional view taken generally along line 5-5 of FIG. 2, with some components and/or panels not shown, or broken away, for clarity;

FIG. 6 is a sectional view taken generally along line 6-6 of FIG. 2, with some components and/or panels not shown, or broken away, for clarity;

FIG. 7 is a sectional view taken generally along line 7-7 of FIG. 2, with some components and/or panels not shown, or broken away, for clarity;

FIG. 8 is a sectional view taken generally along line 8-8 of FIG. 2, with some components and/or panels not shown, or broken away, for clarity;

FIG. 9A is an enlarged fragmentary sectional view taken from FIG. 2, showing the machine configuration as the mold plate in a fill position, with some components and/or panels not shown, or broken away, for clarity;

FIG. 9B is an enlarged fragmentary sectional view taken from FIG. 2, showing the machine configuration as the mold plate in a patty-discharge position, with some components and/or panels not shown, or broken away, for clarity;

FIG. 10 is an elevational view of a tube valve of the present invention;

FIG. 11 is an enlarged fragmentary sectional view taken generally along line 11-11 of FIG. 5, with some components and/or panels not shown, or broken away, for clarity;

FIG. 12 is an enlarged fragmentary sectional view taken generally along line 5-5 of FIG. 2, with some components and/or panels not shown, or broken away, for clarity;

FIG. 12A is an elevational view of a bushing taken from FIG. 11;

FIG. 13 is a view taken generally of along line 13-13 of FIG. 12;

FIG. 13A is a sectional view taken generally along line 13A-13A of FIG. 13;

FIG. 14 is a diagrammatic view of a lube oil system of the invention;

FIG. 15 is an enlarged, fragmentary sectional view taken from the right side of FIG. 6;

FIG. 16 is an enlarged, fragmentary longitudinal sectional view taken from the left side of FIG. 2, with some components and/or panels not shown, or broken away, for clarity;

FIG. 17 is a sectional view taken generally along line 17-17 of FIG. 2, with some components and/or panels not shown, or broken away, for clarity;

FIG. 17A is a fragmentary sectional view taken from FIG. 17, with some components removed for clarity; and

FIG. 18 is a sectional view taken generally along line 18-18 of FIG. 17, with some components and/or panels not shown, or broken away, for clarity.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

General Description Of the Apparatus

The high-speed food patty molding machine 20 illustrated in these figures comprises a preferred embodiment of the invention. The complete machine is described in U.S. Ser. No. ______, identified as attorney docket number 2188P0390US, filed on the same day as the present application, and herein incorporated by reference. This application also incorporates by reference U.S. Application Ser. No. 60/503,354, filed Sep. 16, 2003 and U.S. Provisional Application Ser. No. 60/515,585, filed Oct. 29, 2003.

The molding machine 20 includes a machine base 21, preferably mounted upon a plurality of feet 22, rollers or wheels. The machine base 21 supports the operating mechanism for machine 20 and can contains hydraulic actuating systems, electrical actuating systems, and most of the machine controls. The machine 20 includes a supply 24 for supplying moldable food material, such as ground beef, fish, or the like, to the processing mechanisms of the machine.

A control panel 19, such as a touch screen control panel, is arranged on a forward end of the apparatus 20 and communicates with a machine controller.

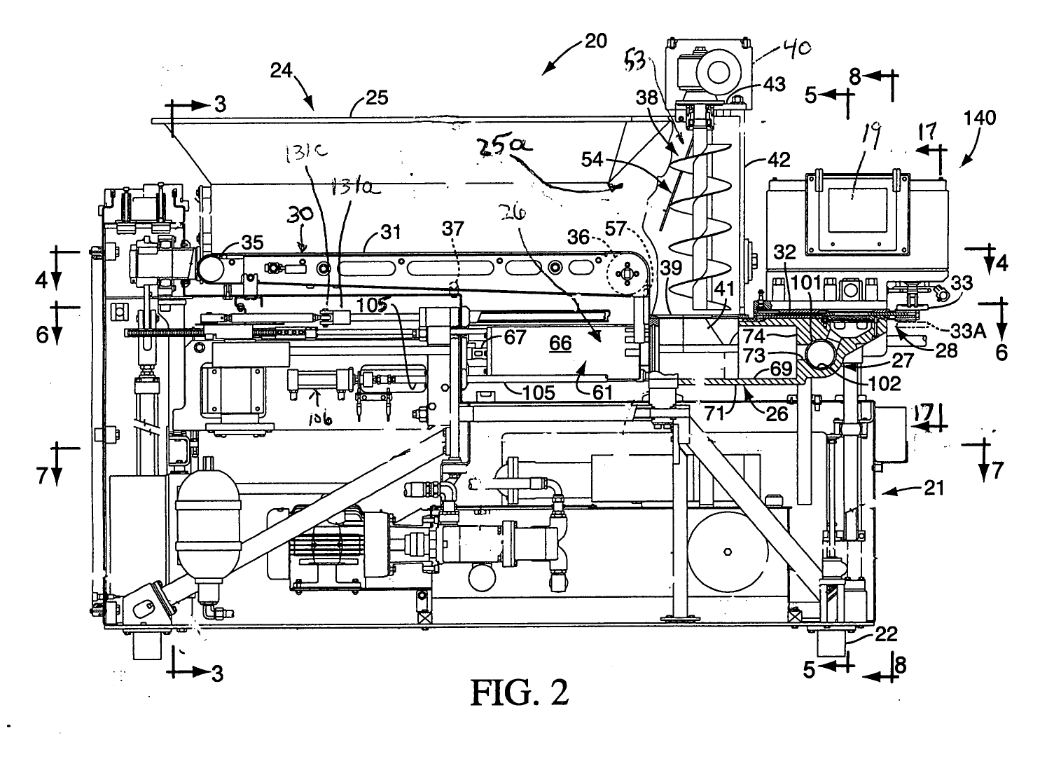

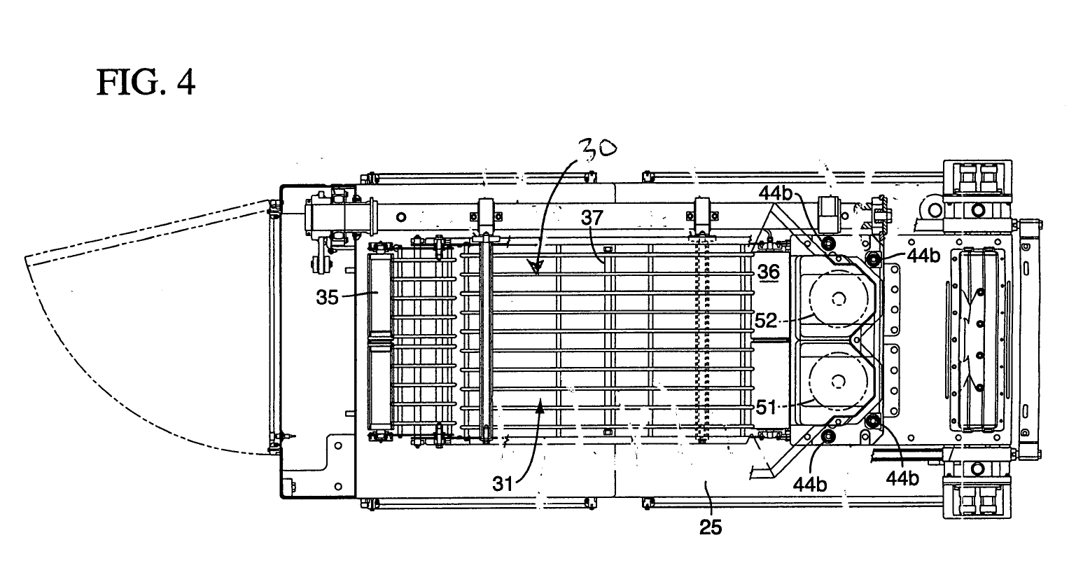

As generally illustrated in FIGS. 2-6, supply means 24 comprises a large food material storage hopper 25 that opens into the intake of a food pump system 26. The food pump system 26 includes at least two food pumps 61, 62, described in detail hereinafter, that continuously, or intermittently under a pre-selected control scheme, pump food material, under pressure, into a manifold 27 flow-connected to a cyclically operated molding mechanism 28.

In the operation of machine 20, a supply of ground beef or other moldable food material is deposited into hopper 25 from overhead. An automated refill device (not shown) can be used to refill the hopper when the supply of food product therein is depleted. The floor of hopper 25 comprises a conveyor belt 31 of a conveyor 30, for moving the food material longitudinally of the hopper 25 to a hopper forward end 25a.

The food material is moved by supply means 24 into the intake of plunger pumps 61, 62 of pumping system 26. The pumps 61, 62 of system 26 operate in overlapping alteration to each other; and at any given time when machine 20 is in operation, at least one of the pumps is forcing food material under pressure into the intake of manifold 27.

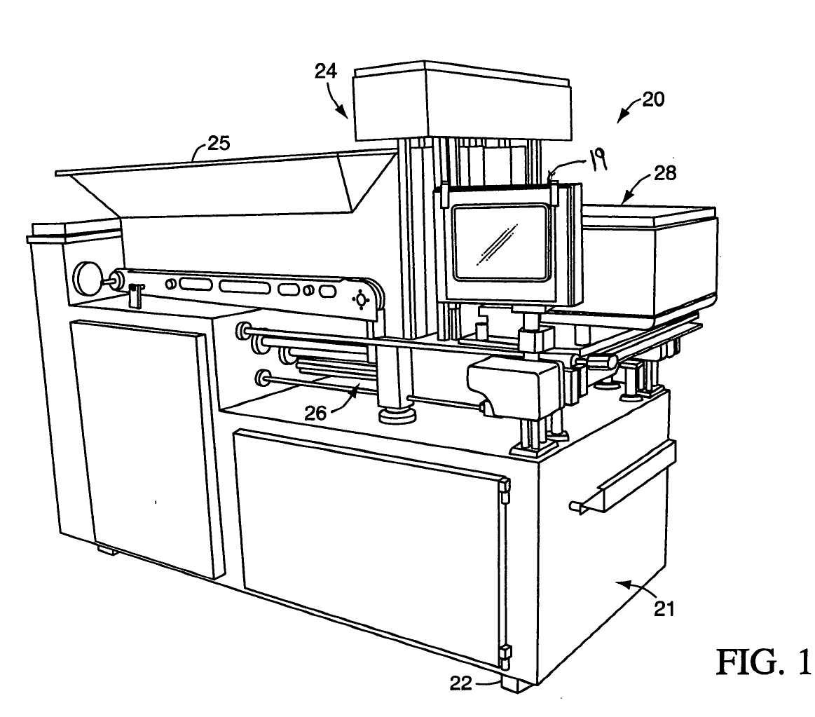

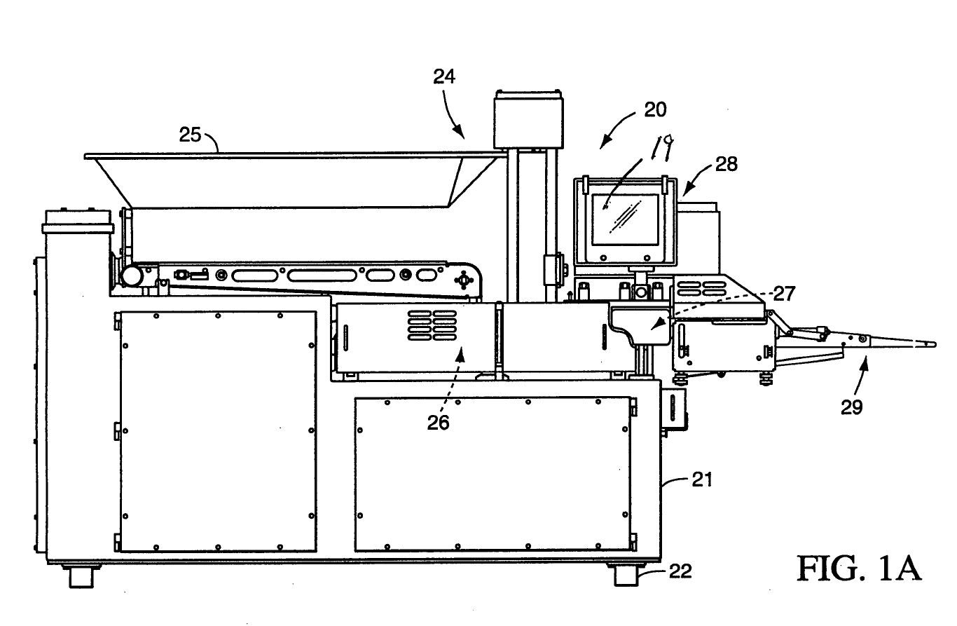

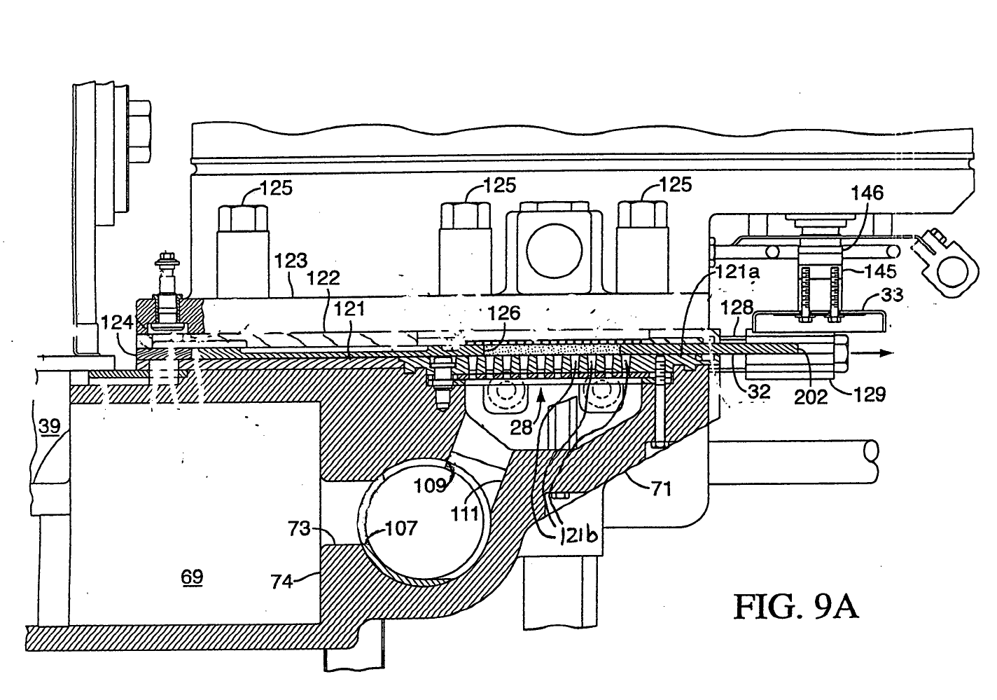

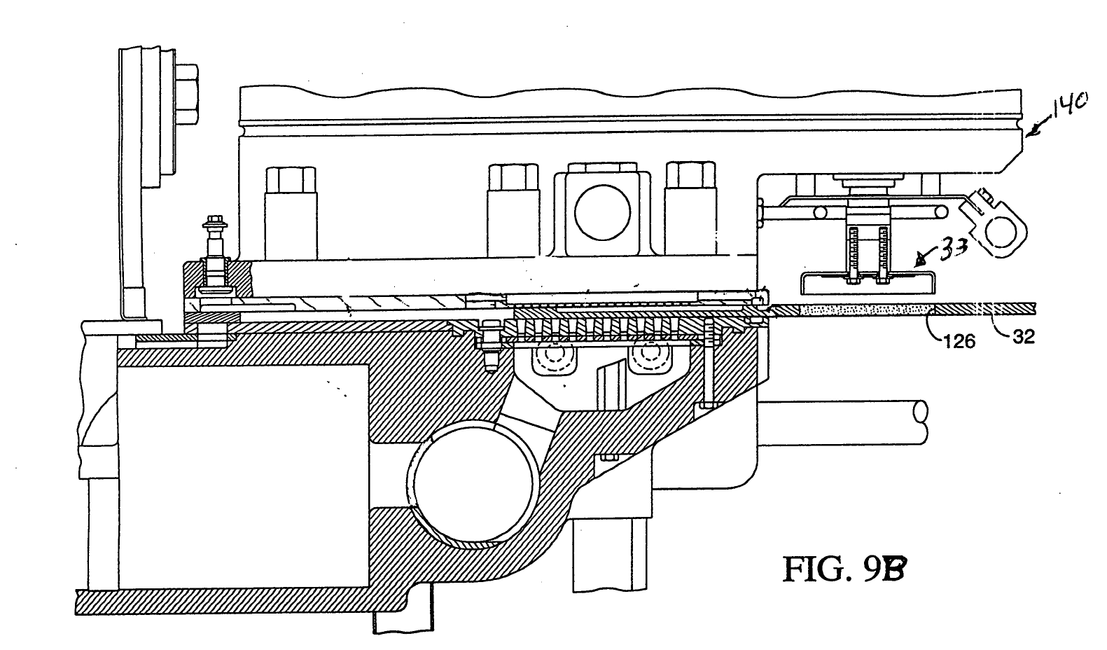

The manifold 27 comprises a system for feeding the food material, still under relatively high pressure, into the molding mechanism 28. Molding mechanism 28 operates on a cyclic basis, first sliding a multi-cavity mold plate 32 into a receiving position over manifold 27 (FIG. 9A) and then away from the manifold to a discharge position (FIG. 9B) aligned with a series of knockout cups 33. When the mold plate 32 is at its discharge position, knockout cups plungers or cups 33 are driven downwardly as indicated by 33A in FIG. 2, discharging hamburgers or other molded patties from machine 20. The molded patties are deposited onto a conveyor 29 (FIG. 1A), to be transported away from the apparatus 20.

Food Supply System

The food supply means 24 and associated hopper 25 are illustrated in FIGS. 2-6. As seen, the conveyor belt 31 spans completely across the bottom of hopper 25, around an end of idler roller or pulley 35 and drive roller or pulley 36, the lower portion of the belt being engaged by a tensioning idle roller 37. A drum motor (not visible) is provided within the drive roller 36 for rotating the drive roller.

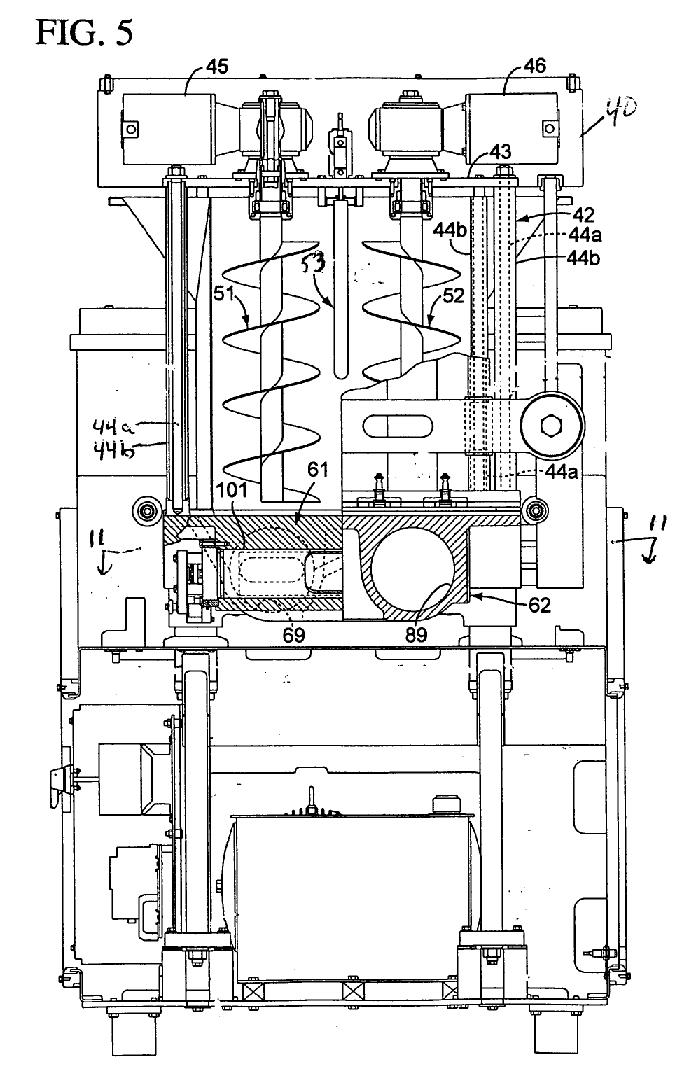

The forward end 25a of hopper 25 communicates with a vertical pump 38 having an outlet 39 at least partly open into a pump intake chamber 41. A vertically oriented frame 42 extends above hopper 25 adjacent the right-hand side of the outlet 39. A motor housing 40 is mounted on top of the frame 42. A support plate 43 is affixed to the upper portion of frame 42, extending over the outlet 39 in hopper 25. The frame comprises four vertical tie rods 44a surrounded by spacers 44b (FIG. 5).

As shown in FIG. 5, the vertical pump 38 comprises two feed screw motors 45, 46 that drive feed screws 51, 52. The two electrical feed screw motors 45, 46 are mounted within the motor housing 40 upon the support plate 43. Motor 45 drives the feed screw 51 that extends partly through opening 39 in alignment with a pump plunger 66 of the pump 61. Motor 46 drives the feed screw 52 located at the opposite side of hopper 25 from feed screw 51, and aligned with another pump plunger 68 of the pump 62.

A level sensing mechanism 53 is located at the outlet end of hopper 25. The mechanism is shown in detail in FIG. 45. The mechanism 53 comprises an elongated sensing element 54. As the moldable food material is moved forwardly in the hopper 25, it may accumulate to a level in which it engages and moves the sensing element 54 to a pre-selected degree. When this occurs, a signal is generated to stop the drive for the roller 36 of conveyor 31. In this manner the accumulation of food material at the forward end 25a of hopper 25 is maintained at an advantageous level.

When machine 20 is in operation, the feed screw motor 45 is energized whenever plunger 66 is withdrawn to the position shown in FIG. 2, so that feed screw 51 supplies meat from hopper 25 downwardly through outlet 39 into one side of the intake 41 of the food pumping system 26. Similarly, motor 46 actuates the feed screws 52 to feed meat to the other side of intake 41 whenever plunger 68 of the pump 62 is withdrawn. In each instance, the feed screw motors 45, 46 are timed to shut off shortly after the plunger is fully retracted, avoiding excessive agitation of the meat. As the supply of food material in the outlet 39 is depleted, the conveyor belt 31 continuously moves food forwardly in the hopper and into position to be engaged by the feed screws 51, 52. If the level of meat at the outlet 39 becomes excessive, conveyor 31 is stopped, as described above, until the supply at the hopper outlet is again depleted.

The wall of the outlet 39 immediately below conveyor drive rollers 36 comprises a belt wiper plate 57 that continuously engages the surface of the conveyor 31 to prevent leakage of the food material 38 from the hopper at this point.

Food Pump System

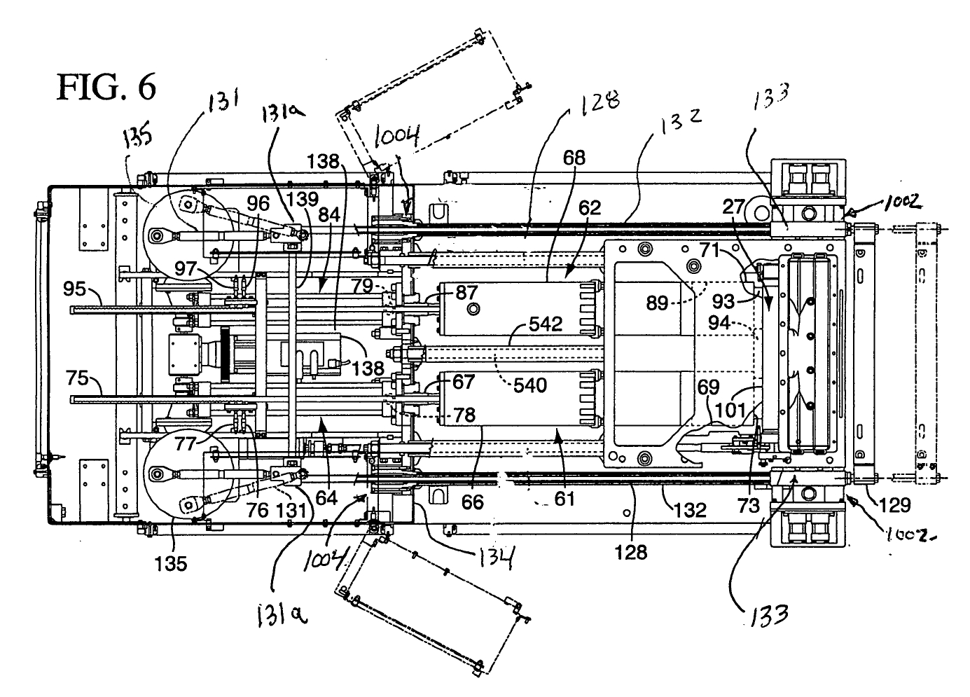

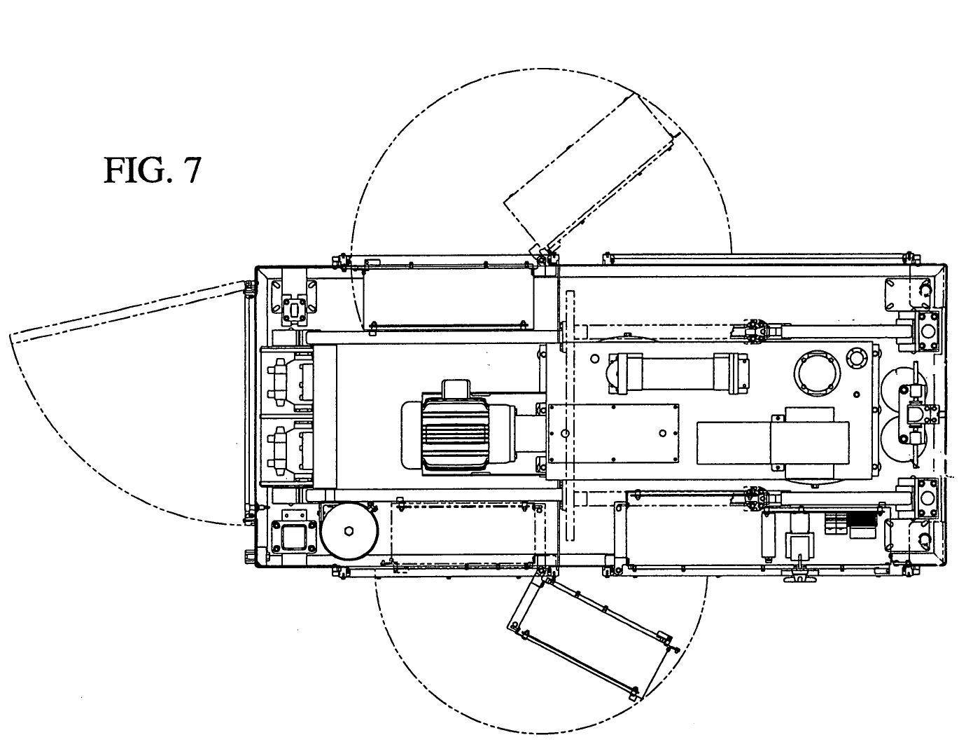

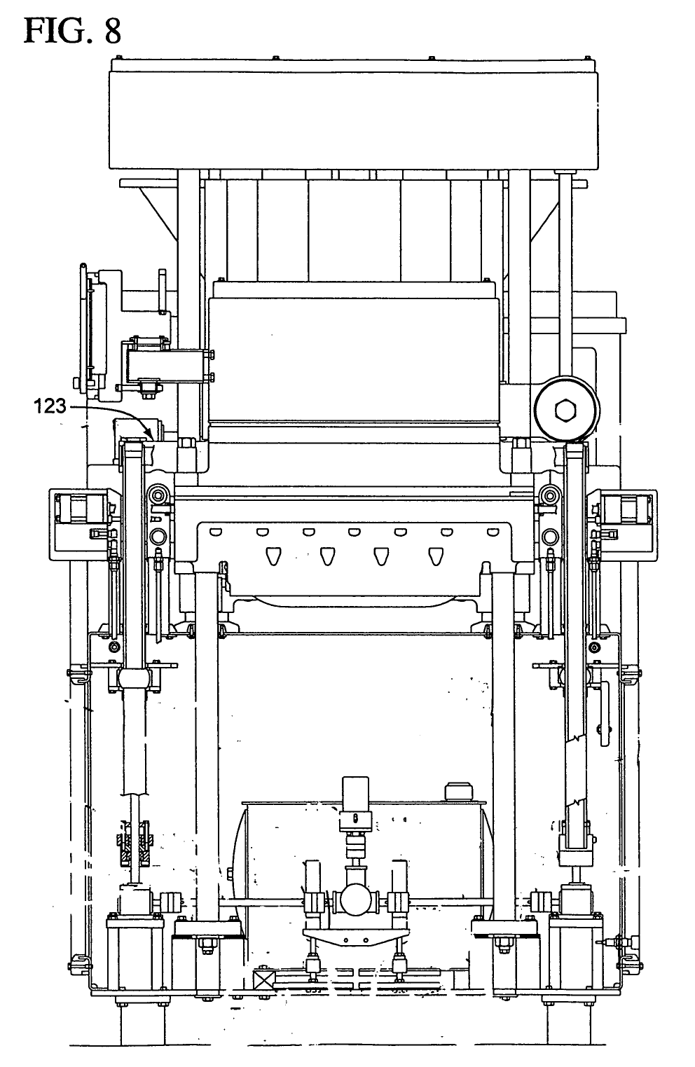

The food pump system 26 of molding machine 20 is best illustrated in FIGS. 2 and 6. Pump system 26 comprises the two reciprocating food pumps 61, 62 mounted on the machine base 21. The first food pump 61 includes a hydraulic cylinder 64. The piston in cylinder 64 (not shown) is connected to an elongated piston rod 67; the outer end of the elongated piston rod 67 is connected to the large plunger 66. The plunger 66 is aligned with a first pump cavity 69 formed by a pump cavity enclosure or housing 71 that is divided into two pump chambers. The forward wall 74 of pump cavity 69 has a relatively narrow slot 73 that communicates with the valve manifold 27 as described more fully hereinafter.

The pump housing 71 and the manifold 27 are preferably formed as a one piece stainless steel part.

The second food pump 62 is essentially similar in construction to pump 61 and comprises a hydraulic cylinder 84. Cylinder 84 has an elongated piston rod 87 connected to the large plunger 68 that is aligned with a second pump cavity 89 in housing 71. The forward wall 94 of pump cavity 89 includes a narrow elongated slot 93 communicating with manifold 27.

Advantageously, the plungers 66, 68 and the pump cavities 69, 89 have corresponding round cross sections for ease of manufacturing and cleaning.

As shown in FIG. 6, an elongated proximity meter 75 is affixed to the first pump plunger 66 and extends parallel to piston rod 67 into alignment with a pair of proximity sensors 76 and 77. A similar proximity meter 95 is fixed to and projects from plunger 68, parallel to piston rod 87, in alignment with a pair of proximity sensors 96, 97. Proximity sensors 76, 77 and 96, 97 comprise a part of the control of the two pumps 61, 62.

In operation, the first pump 61 pumps the moldable food material into manifold 27 and the second pump 62 receives a supply of the moldable food material for a subsequent pumping operation. Pump 61 begins its pumping stroke, and compresses food product in pump cavity 69, forcing the moldable food material through slot 73 into manifold 27. As operation of molding machine 20 continues, pump 61 advances plunger 66 to compensate for the removal of food material through manifold 27. The pump can maintain a constant pressure on the food material in the chamber 69 during the molding cycle, or preferably can provide a pre-selected pressure profile over the molding cycle such as described in U.S. Pat. No. 4,356,595, incorporated herein by reference, or as utilized in currently available FORMAX machines. The pressure applied through pump 61 is sensed by a pressure sensing switch 78 connected to a port of the cylinder 64.

As plunger 66 advances, the corresponding movement of proximity meter 75 signals the sensor 76, indicating that plunger 66 is near the end of its permitted range of travel. When this occurs, pump 62 is actuated to advance plunger 68 through pump cavity 89, compressing the food material in the second pump cavity in preparation for feeding the food material from the cavity into manifold 27. The pressure applied through pump 62 is sensed by a pressure sensing switch 79 connected to one port of cylinder 84.

When the food in the second pump cavity 89 is under adequate pressure, the input to manifold 27 is modified so that subsequent feeding of food product to the manifold is effected from the second pump cavity 89 with continuing advancement of plunger 68 of the second pump 62. After the manifold intake has been changed over, pump 61 is actuated to withdraw plunger 66 from cavity 69.

Thereafter, when plunger 68 is near the end of its pressure stroke into pump cavity 89, proximity sensor 96, signals the need to transfer pumping operations to pump 61. The changeover process described immediately above is reversed; pump 61 begins its compression stroke, manifold 27 is changed over for intake from pump 61, and pump 62 subsequently retracts plunger 68 back to the supply position to allow a refill of pump cavity 89. This overlapping alternating operation of the two pumps 61, 62 continues as long as molding machine 20 is in operation.

The valve manifold 27, shown in FIGS. 2 and 6, holds a valve cylinder or tube valve 101 fit into an opening 102 in housing 71 immediately beyond the pump cavity walls 74 and 94.

According to the embodiment illustrated in FIGS. 5, 6 and 10-12, the valve cylinder 101 includes two longitudinally displaced intake slots 107 and 108 alignable with the outlet slots 73 and 93, respectively, in the pump cavity walls 74 and 94. Slots 107 and 108 are angularly displaced from each other to preclude simultaneous communication between the manifold and both pump cavities 69 and 89. Cylinder 101 also includes an elongated outlet slot 109. The valve cylinder outlet slot 109 is generally aligned with a slot 111 (see FIG. 9A) in housing 71 that constitutes a feed passage for molding mechanism 28.

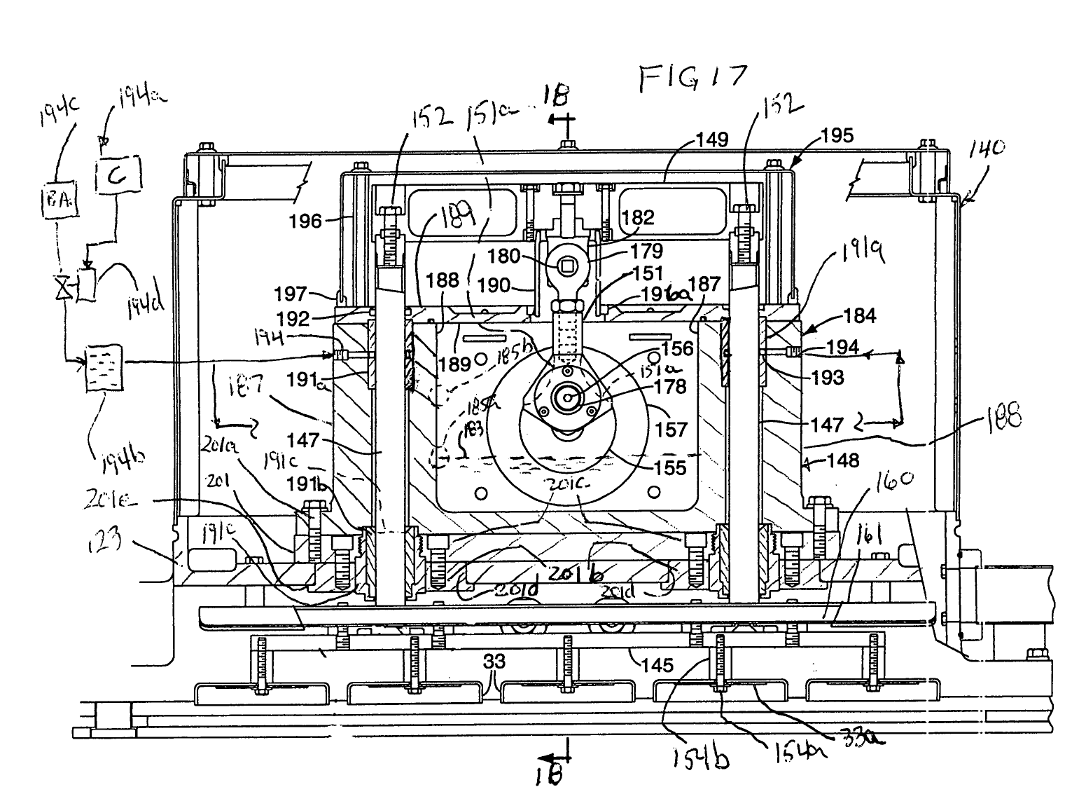

One end wall of valve cylinder 101 includes an externally projecting base end 103 that is connected to a drive linkage 104, in turn connected to the end of the piston rod 105 of a hydraulic actuator cylinder 106 (FIGS. 2 and 16).

When the pump 61 is supplying food material under pressure to molding mechanism 28, actuator cylinder 106 has retracted piston rod 105 to the inner limit of its travel, angularly orienting the valve cylinder 101. With cylinder 101 in this position, its intake slot 107 is aligned with the outlet slot 73 from pump cavity 69 so that food material is forced under pressure from cavity 69 through the interior of valve cylinder 101 and out of the valve cylinder outlet slot 109 through slot 111 to the molding mechanism 27. On the other hand, the second intake slot 108 of valve cylinder 101 is displaced from the outlet slot 93 for the second pump cavity 89. Consequently, the food material forced into the interior of valve cylinder 101 from pump cavity 69 cannot flow back into the other pump cavity 89.

Tube Valve System

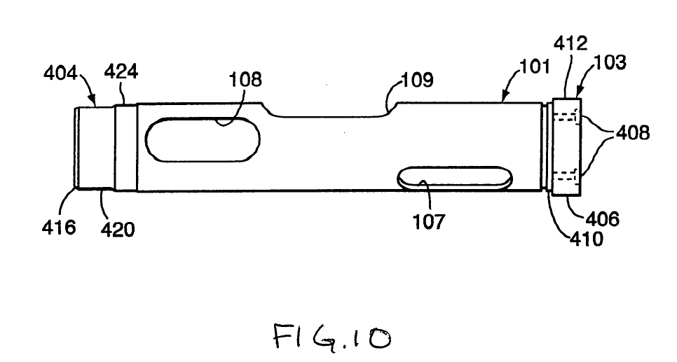

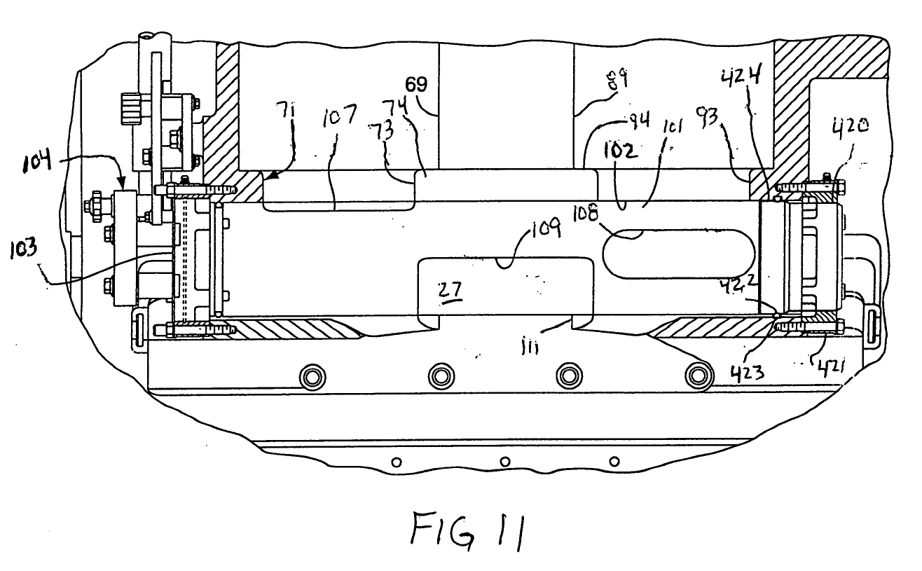

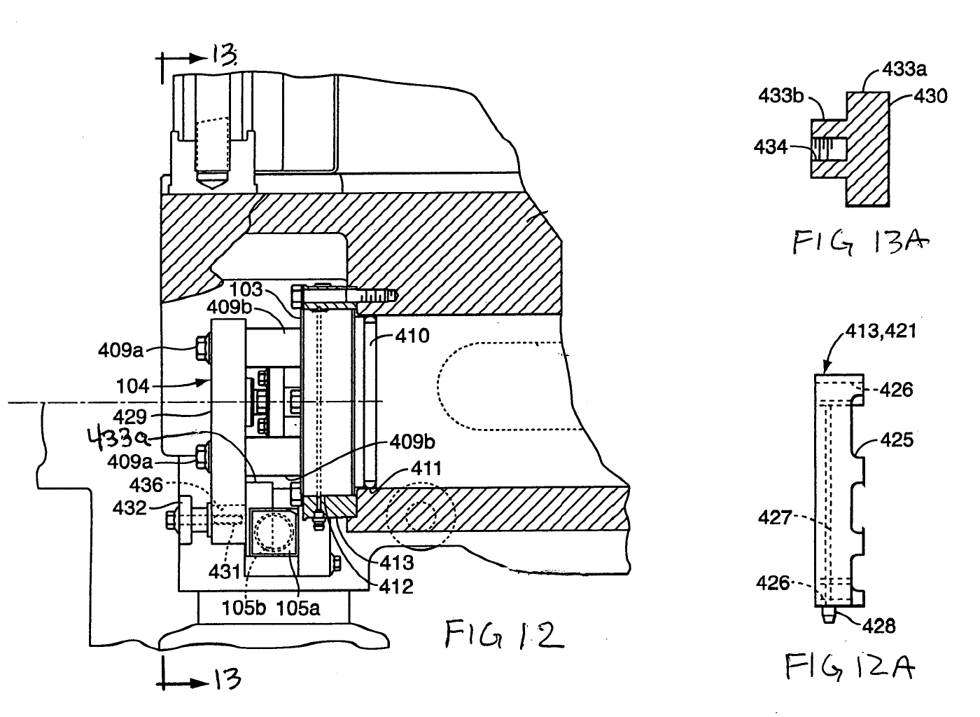

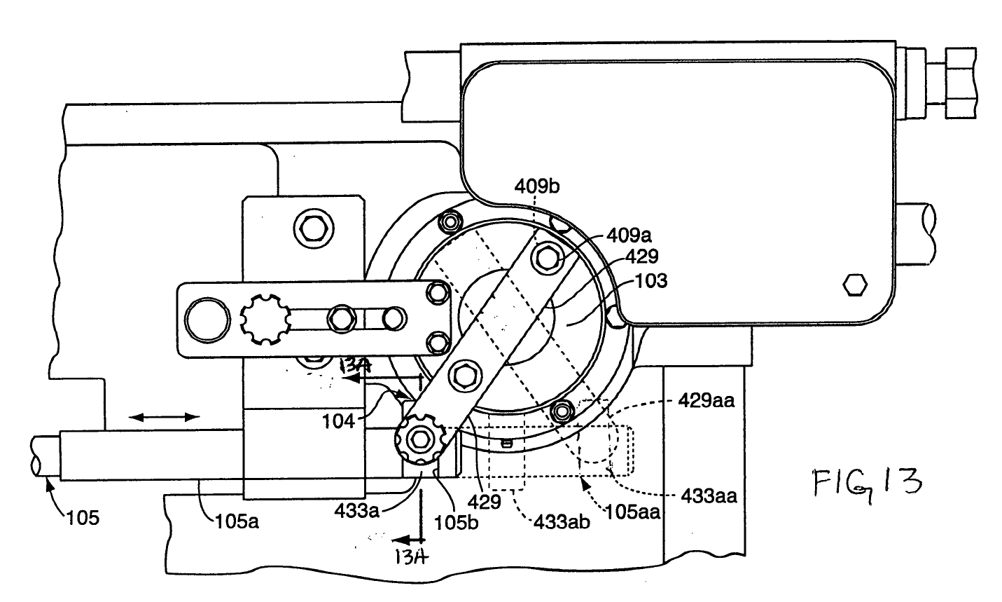

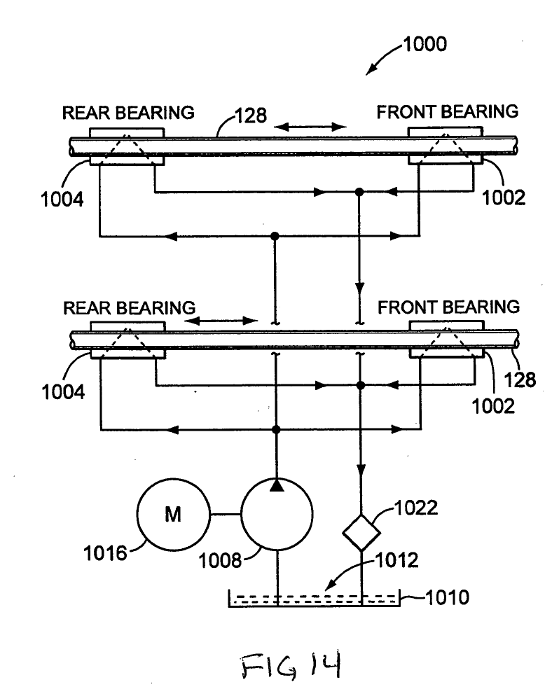

FIG. 10 illustrates the tube valve 101 separate from the apparatus 20. The tube valve includes the base end 103 and a distal end 404. The distal end 404 is inserted first into the opening 102 of the housing 71 during installation. The base end 103 includes an end flange 406 having two tapped holes 408 for connection to the drive link 104 by fasteners 409a and spacers 409b as shown in FIG. 13. The base end 103 further includes a groove 410 for an o-ring seal 411 and a smooth annular surface 412 that is journaled within a base end bearing or bushing 413 shown in FIGS. 11, 12 and 12A.

The distal end 404 includes a reduced diameter guide portion 416 that positions a smooth annular surface 420 into a distal end bearing or bushing 421 as shown in FIG. 11. A ring seal 422 is positioned within an inside groove 423 of the opening 182. A smooth annular surface 424 of the distal end 404 engages and seals against the ring seal 422 (FIG. 11).

As illustrated in FIG. 12A, both bushings 413, 421 include a crown-shaped profile having openings 425 spaced around a circumferential surface that abuts the manifold 27 when installed. Each bushing 413, 421 include openings 426 for fasteners to fasten the bushings 413, 421 to the manifold 27, and an inside circumferential grease groove 427 in communication with a grease fitting 428.

As illustrated in FIG. 13, the linkage 104 includes a lever bar 429 that is fastened to the base end 103 by the fasteners 409a, and spacers 409b. The rod 105 includes an extension 105a that has a square cross section. The extension has a rectangular notch 105b that is open towards a back side of the lever bar 429.

A follower block 430 is rotatably connected to the back side of the lever bar 429 by a threaded shank 431 of a knob 432. In this regard, the follower block 430 includes a block portion 433a and a cylinder portion 433b having a threaded bore 434 to engage the shank 431. The lever bar 429 includes a cylindrical bore 436 that receives the cylinder portion 433b. The cylinder portion 433b is free to rotate in the bore 436.

The block portion 433a is free to vertically slide within the notch 105b. Three positions of the block portion 433a are shown in FIG. 25: 433a, 433ab, 433aa. Two positions of the lever bar 429 are shown: 429 and 429aa.

The valve cylinder 101 and corresponding slots or openings can alternately be as described in U.S. Provisional Application 60/571,368, filed May 14, 2004, or U.S. Ser. No. ______, filed on the same day as the present invention and identified by attorney docket number 2188P0381US, both herein incorporated by reference. According to these disclosures, rather than a single outlet 109, two rows of progressively sized outlets, smallest closest to the active pump, are alternately opened to plural openings that replace the single opening 111.

Molding Mechanism

As best illustrated in FIG. 9A, the upper surface of the housing 71 that encloses the pump cavities 69 and 89 and the manifold 27 carries a support plate or wear plate 121 and a fill plate 121a that forms a flat, smooth mold plate support surface. The mold support plate 121 and the fill plate 121a may be fabricated as two plates as shown or a single plate bolted to or otherwise fixedly mounted upon housing 71. The fill plate 121a includes apertures or slots that form the upper portion of the manifold outlet passage 111. In the apparatus illustrated, a multi fill orifice type fill plate 121a is utilized. A simple slotted fill plate is also encompassed by the invention.

Mold plate 32 is supported upon plates 121, 121a. Mold plate 32 includes a plurality of individual mold cavities 126 extending across the width of the mold plate and aligned during a portion of its reciprocating travel with the manifold outlet passageway 111. Although a single row of cavities is shown, it is also encompassed by the invention to provide plural rows of cavities, stacked in aligned columns or in staggered columns. A cover plate 122 is disposed immediately above mold plate 32, closing off the top of each of the mold cavities 126. A mold cover or housing 123 is mounted upon cover plate 122. The spacing between cover plate 122 and support plate 121 is maintained equal to the thickness of mold plate 32 by support spacers 124 mounted upon support plate 121. Cover plate 122 rests upon spacers 124 when the molding mechanism is assembled for operation. Cover plate 122 is held in place by six mounting bolts, or nuts tightened on studs, 125.

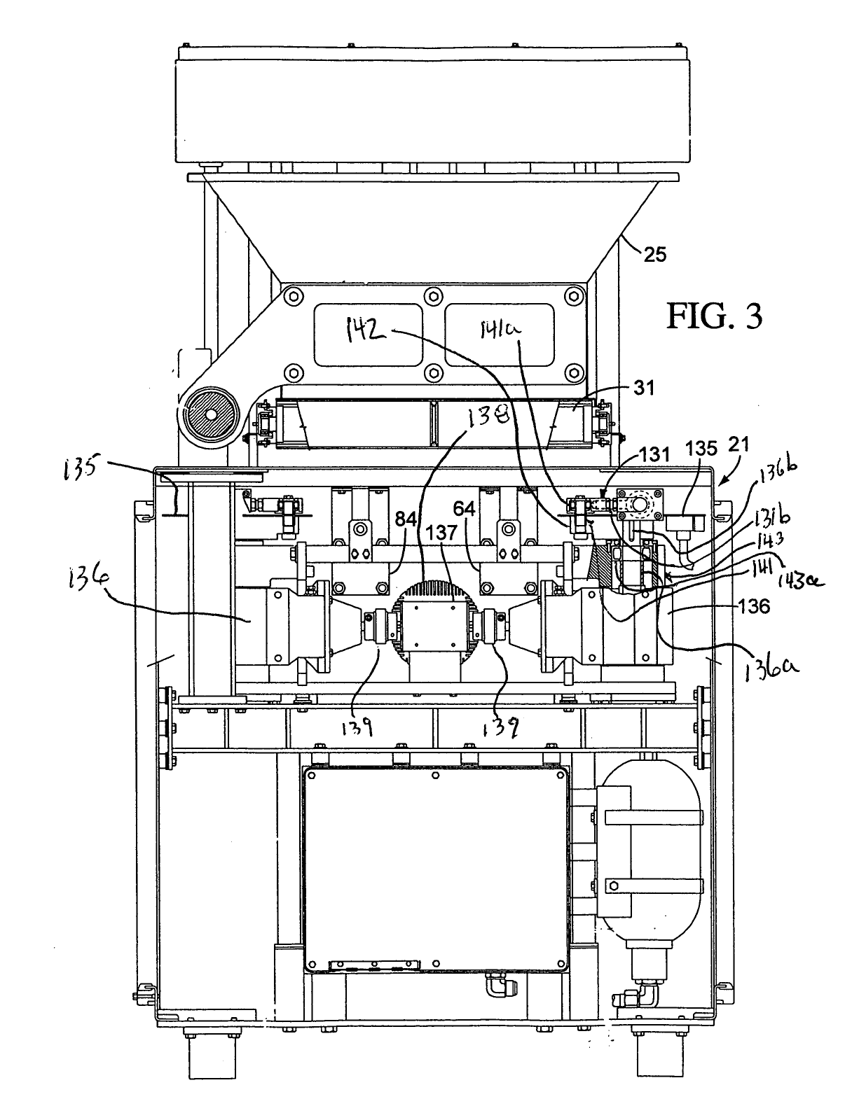

As best illustrated in FIGS. 3 and 6 mold plate 32 is connected to drive rods 128 that extend alongside housing 71 and are connected at one end to a transverse bar 129. The other end of each drive rod 128 is pivotally connected to a connecting link 131 via a coupling plate 131a and a pivot connection 131c, shown in FIG. 16. The pivot connection 131c can include a bearing (not visible in the figures) surrounding a pin 131d within an apertured end 131e of the connecting link 131. The pin 131d includes a cap, or carries a threaded nut, on each opposite end to secure the crank arm to the coupling plate 131a.

Each drive rod 128 is carried within a guide tube 132 that is fixed between a wall 134 and a front bearing housing 133. The connecting links 131 are each pivotally connected to a crank arm 142 via a pin 141 that is journaled by a bearing 141a that is fit within an end portion of the connecting link 131. The pin crank arm 142 is fixed to, and rotates with, a circular guard plate 135. The pin 141 has a cap, or carries a threaded nut, on each opposite end that axially fixes the connecting link 131 to the crank arm 142 and the circular guard plate 135. The connecting link 131 also includes a threaded portion 131b to finely adjust the connecting link length.

The crank arms 142 are each driven by a right angle gear box 136 via a “T” gear box 137 having one input that is driven by a precise position controlled motor 138 and two outputs to the gearboxes 136. The “T” gear box 137 and the right angle gear boxes 136 are configured such that the crank arms 142 rotate in opposite directions at the same rotary speed.

The precise position controlled motor can be a 6-7.5 HP totally enclosed fan cooled servo motor. The servo motor is provided with two modules: a power amplifier that drives the servo motor, and a servo controller that communicates precise position information to a machine controller.

The controller and the servo motor 138 are preferably configured such that the servo motor rotates in an opposite rotary direction every cycle, i.e., clockwise during one cycle, counterclockwise the next cycle, clockwise the next cycle, etc.

A bearing housing 143 is supported on each gearbox 136 and includes a rotary bearing 143a therein to journal an output shaft 136a of the gear box 136. The output shaft 136a is fixed to the crank arm 142 by a clamp arrangement formed by legs of the crank arm 142 that surround the output shaft and have fasteners that draw the legs together to clamp the output shaft between the legs (not shown), and a longitudinal key (not shown) fit into a keyway 136b on the output shaft and a corresponding keyway in the crank arm 142 (not shown).

A tie bar 139 is connected between the rods 128 to ensure a parallel reciprocation of the rods 128. As the crank arms 142 rotate in opposite rotational directions, the outward centrifugal force caused by the rotation of the crank arms 142 and the eccentric weight of the attached links 131 cancels, and separation force is taken up by tension in the tie bar 139.

One circular guard plate 135 is fastened on top of each crank arm 142. The pin 141 can act as a shear pin. If the mold plate should strike a hard obstruction, the shear pin can shear by force of the crank arm 142. The guard plate 135 prevents an end of the link 131 from dropping into the path of the crank arm 142.

During a molding operation, the molding mechanism 28 is assembled as shown in FIGS. 2 and 9A, with cover plate 122 tightly clamped onto spacers 124.

In each cycle of operation, knockout cups 33 are first withdrawn to the elevated position as shown in FIG. 9B. The drive for mold plate 32 then slides the mold plate from the full extended position to the mold filling position illustrated in FIGS. 2 and 9A, with the mold cavities 126 aligned with passageway 111.

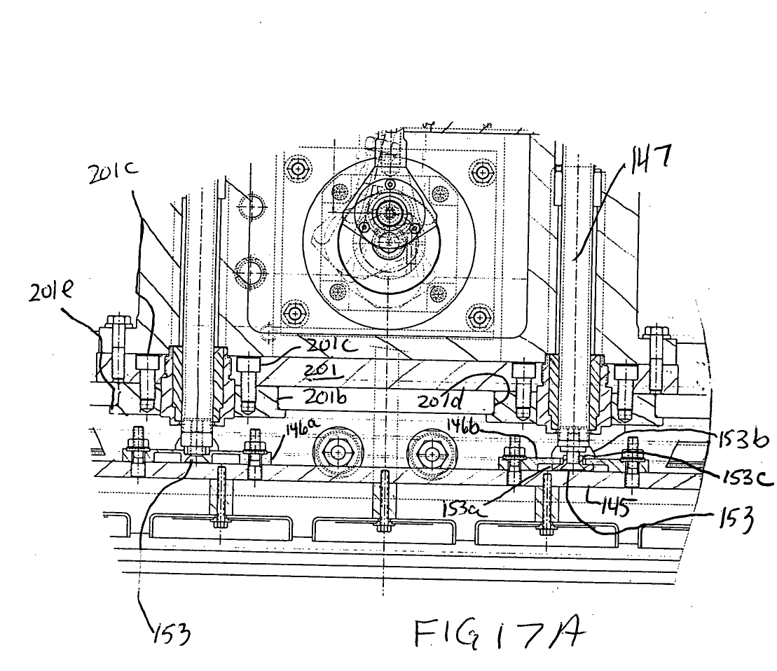

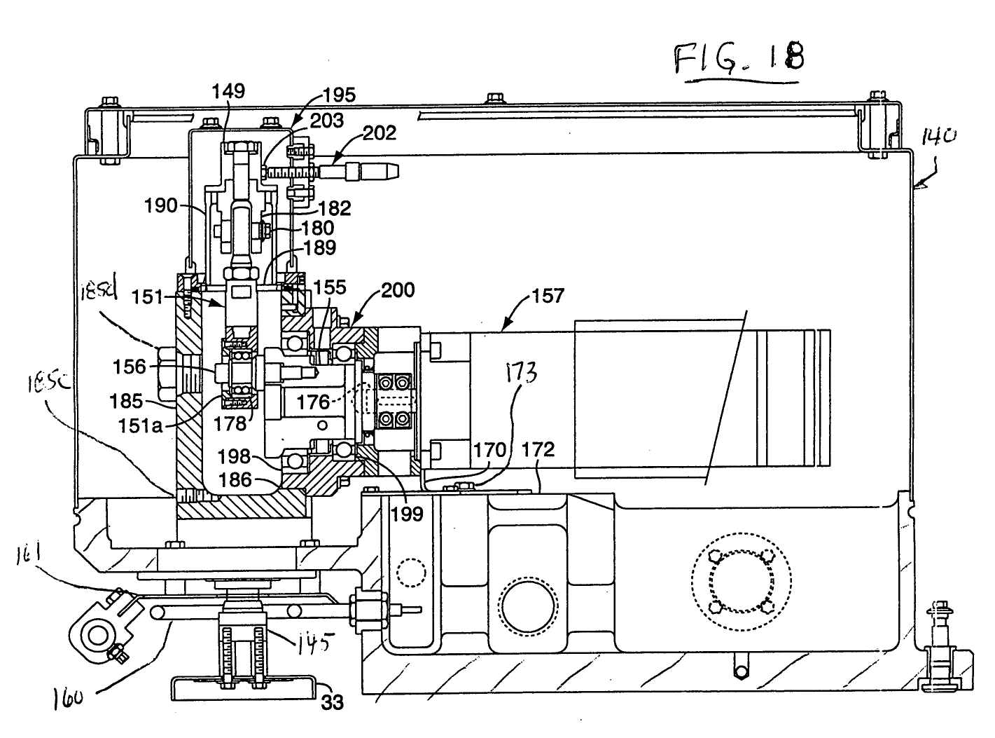

During most of each cycle of operation of mold plate 32, the knockout mechanism remains in the elevated position, shown in FIGS. 17 and 18, with knockout cups 33 clear of mold plate 32. When mold plate 32 reaches its extended discharge position as shown in FIG. 9B the knockout cups 33 are driven downward to discharge the patties from the mold cavities. The discharged patties may be picked up by the conveyor 29.

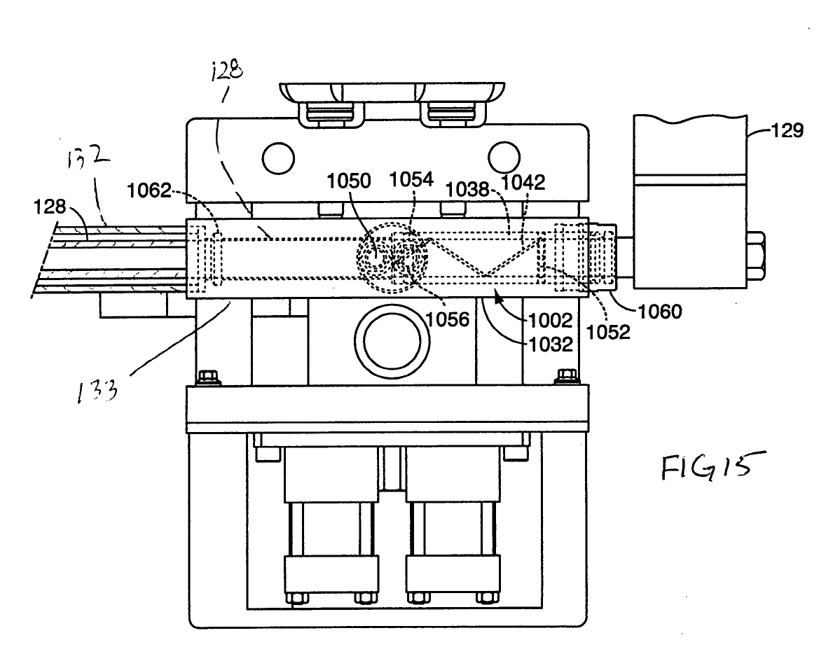

FIG. 14 illustrates a mold drive rod lubricating system 1000 incorporated into the apparatus 20. The lubrication system 1000 includes front bearings 1002 and rear bearings 1002 for each drive rod 128. The location of the bearings is shown in FIG. 6.

A pump 1008 takes suction from reservoir 1010 holding lubricating oil 1012. A motor 1016 being either an electric, hydraulic, pneumatic or other type motor, drives the pump. The pump circulates lubricating oil through tubing and/or passages through the machine base area to the bearings 1002, 1004 and returns the lubricating oil through a filter 1022 to the reservoir. The pump, motor, reservoir and filter are all located within the machine base 21.

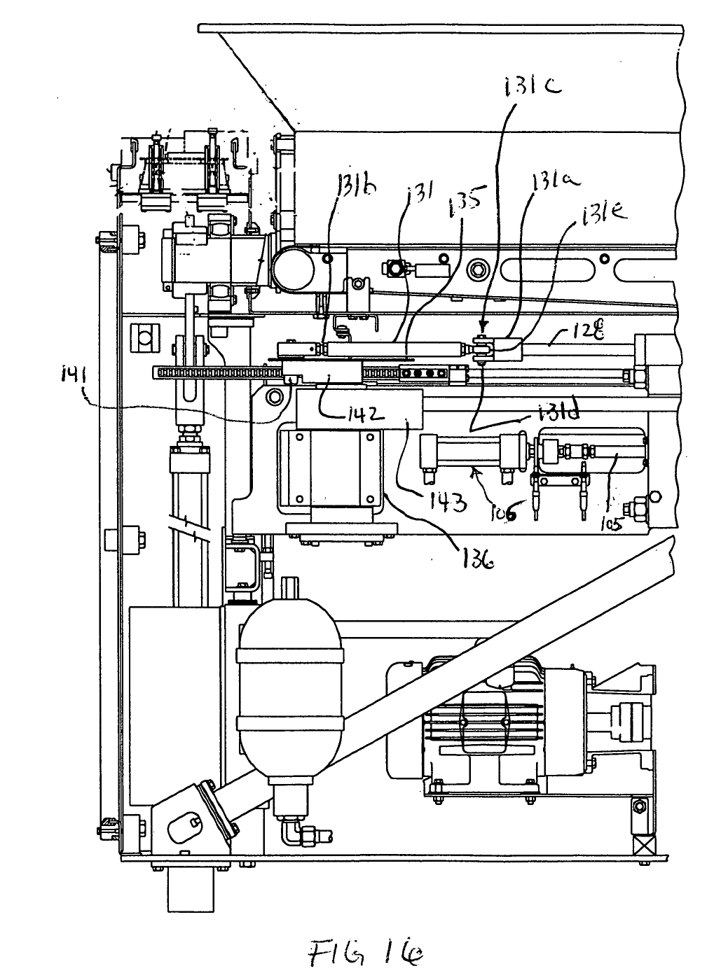

FIG. 15 illustrates a front bearing 1002. The other front bearing and the rear bearings 1004 are configured in substantially identical manner. The front bearing 1002 includes a housing 1032 having an internal bore 1036 for holding a sleeve bearing element 1038. The sleeve bearing element 1038 has an inside surface sized to guide the drive rod 128 and has a helical groove 1042 facing and surrounding the drive rod 128. An oil inlet port 1050 communicates lubricating oil into an open end of the helical groove. Lubricating oil proceeds through the helical groove to an opposite end of the bearing element 1038 to a first outlet groove 1052 in communication with a second outlet groove 1054 through a longitudinal channel (not shown). The second outlet groove 1054 is in communication with an outlet port 1056. The inlet port 1050 is in fluid communication with the pump 1008 and the outlet port 1056 is in fluid communication with the oil return lines to the filter 1022. A front seal 1060 and a rear seal 1062 retain oil within the housing 1032.

Knockout System

Molding mechanism 28 further comprises a knockout apparatus 140 shown in FIGS. 2, 9A, 17-18. The knockout apparatus comprises the knockout plungers or cups 33, which are fixed to a carrier bar 145. Knockout cups 33 are coordinated in number and size to the mold cavities 126 in the mold plate 32. One knockout cup 33 is aligned with each mold cavity 126. The mold cavity size is somewhat greater than the size of an individual knockout cup.

The knockout apparatus 140 is configured to drive the carrier bar 145 in timed vertical reciprocation.

FIGS. 17-18 illustrate the knockout apparatus 140 in more detail. The carrier bar 145 is fastened to knockout support brackets 146a, 146b. The knockout support brackets 146a, 146b are carried by two knockout rods 147. Each knockout rod 147 is disposed within a wall of a knockout housing 148 and is connected to a knockout beam 149.

The knockout beam 149 is pivotally mounted to a crank rod 151 that is pivotally connected to a fastener pin 156 that is eccentrically connected to a crank hub 155 that is driven by a motor 157.

The motor is preferably a precise position controlled motor, such as a servo motor. An exemplary servomotor for this application is a 3000 RPM, 2.6 kW servo motor provided with a brake. The servo motor is provided with two modules: a power amplifier that drives the servo motor, and a servo controller that communicates precise position information to the machine controller.

The controller and the motor 157 are preferably configured such that the motor rotates in an opposite direction every cycle, i.e., clockwise during one cycle, counterclockwise the next cycle, clockwise the next cycle, etc.

A heating element 160 surrounds, and is slightly elevated from the knockout carrier bar 145. A reflector 161 is mounted above the heating element 160. The heating element heats the knock out cups to a pre-selected temperature, which assists in preventing food product from sticking to the knock out cups.

In FIGS. 17-18, the crank hub 155 is rotated into a position wherein the crank rod 151 is vertically oriented and the knockout beam 149 is lifted to its maximum elevation. The knockout rods are fastened to the knockout beam 149 by fasteners 152. The knockout support brackets 146a, 146b are in turn fastened to the knockout rods 147 by fasteners 153. Each knockout cup 33 is fastened to the knockout carrier bar by a pair of fasteners 154a and spacers 154b. An air flap or air check valve 33a can be provided within each cup to assist in dispensing of a meat patty from the cup 33.

As shown in FIG. 18, the motor 157 is supported by a bracket 170 from a frame member 172 that is mounted to the casting 123. The bracket 170 includes one or more slotted holes, elongated in the longitudinal direction (not shown). One or more fasteners 173 penetrate each slotted hole and adjustably fix the motor 157 to the frame member. The motor 157 includes an output shaft 176 that is keyed to a base end of the crank hub 155. The fastener pin 156 retains a roller bearing 178 thereon to provide a low friction rotary connection between an annular base end 151a of the crank rod 151 and the pin 156.

The crank rod 151 has an apertured end portion 179 on an upper distal end 151b opposite the base end 151a. The apertured end portion 179 is held by a fastener pin assembly 180 through its aperture to a yoke 182. The yoke 182 is fastened to the knockout beam 149 using fasteners. The fastener pin assembly 180 can include a roller or sleeve bearing (not shown) in like fashion as that used with the fastener pin 156 to provide a reduced friction pivot connection.

The housing 148 is a substantially sealed housing that provides an oil bath. Preferably, the housing walls and floor is formed as a cast aluminum part. The crank hub 155, the pin 156, roller bearing 178, the apertured end portion 179, the fastener pin 180 and the yoke 182 are all contained within the oil bath having an oil level 183. The limits of the oil bath are defined by a housing 184 having a front wall 185, a rear wall 186, side walls 187, 188, a top wall 189 and a sleeve 190. The sleeve 190 is a square tube that surrounds a substantial portion of the crank rod 151 and is sealed around its perimeter to the top wall 189 by a seal element 196a. The sleeve 190 is connected to the beam 149 and penetrates below the top wall 189. As the yoke 182 reciprocates vertically, the beam 149 and the sleeve 190 reciprocate vertically, the sleeve 190 maintaining a sealed integrity of the oil bath.

The crank rod 151 includes side dished areas 151a that act to scoop and propel oil upward during rotation of the hub 155 to lubricate the pin 180 and surrounding areas.

The knockout rods 147 are guided to reciprocate through the side walls 187, 188, particularly, through upper and lower bearings 191a, 191b. The rods 147 are sealed to the top wall by seals 192. The bearings 191a can include an internal groove 193 that is in flow-communication with a lubricant supply through port 194.

A lubricant system 194a is provided to provide lubricant to the bearings 191a, 191b. The system 194a includes a lubricant reservoir 194b that is filled with lubricant, such as oil, and connected to plant air 194c via an electronically controlled valve 194d. The machine controller C periodically, according to a preset routine, actuates the valve 194d to propel some lubricant into the bearings 191a. Lubricant can run down the knockout rod 147 into a dished top 191c of the lower bearings 191b to allow oil to penetrate between the knockout rods 147 and the lower bearings 191b.

An outer cover 195 is fastened and sealed around the side walls 187, 188 and front and rear walls 185, 186 by fasteners, spacers 196 and a seal 197. Any lubricating oil that passes through the seal can be returned to the oil bath via dished out drain areas and drain ports through the top wall.

The front wall 185 includes an oil level sight glass 185a, a fill port 185b (shown dashed in FIG. 17), a drain port 185c (FIG. 18); and an access hole closed by a screw 185d (FIG. 18).

The crank hub 155 is journaled for rotation by two roller bearings 198, 199. The roller bearings 198, 199 are supported by a collar assembly 200 bolted to the rear wall 186 and to the motor 157.

The knockout assembly is changeable to extend further forwardly to minimize knockout cup cantilever. This is accomplished by loosening the bracket 170 from the frame member 172 and sliding the motor and all the connected parts forward or rearward and replacing circular adapter plates for the knockout rods 147.

The housing 148 is fastened to a support plate 201 by fasteners 201a. The support plate 201 is fastened to circular adapter plates 201b by fasteners 201c. The circular adapter plates 201b are removably fit into circular holes 201d in the casting 123. The circular adapter plates 201b include a bottom flange 201e which abuts the casting 123. The circular adapter plates 201b surround the bearings 191b and associated bearing assemblies 191c.

As shown in FIG. 17A, the left bracket 146a is fixedly connected to the left knockout rod 147 using the fastener 153 while the right bracket 146b is connected for a sliding connection. In this regard the right fastener 153 passes through an inverted T-nut 153a that passes through the bracket 146b and fits into a back up washer 153b that abuts the top side of the bracket 146b. The bracket 146b includes an oversized opening in the lateral direction that allows the bracket 146b to shift laterally with respect to the T-nut and knockout rod 147. This arrangement allows the bar 145 to expand and contract laterally with respect to the knockout rods 147. When the knockout cups 33 are heated by the heating element 160, the carrier bar 145 can become heated as well. Preferably, the carrier bar 145 is composed of aluminum which can expand to a significant degree. The sliding connection of the bracket 146b accommodates this thermal expansion.

The knockout assembly is changeable to extend further forwardly to minimize knockout cup cantilever and stress in supporting members. This is accomplished by loosening the bracket 170 from the frame member 172 and sliding the motor 157 and the connected parts forward or rearward and replacing the circular adapter plates that guide the knockout rods 147.

A proximity sensor 202 is bolted to the outer cover 195, and a target 203 is provided on the crank beam 149 to be sensed by the proximity sensor 202. The proximity sensor 202 communicates to the controller that the knockout cups are raised and the mold plate can be retracted without interfering with the knockout cups.

From the foregoing, it will be observed that numerous variations and modifications may be effected without departing from the spirit and scope of the invention. It is to be understood that no limitation with respect to the specific apparatus illustrated herein is intended or should be inferred.

1. A lubrication system for a patty-forming apparatus of the kind having a reciprocating mold plate driven by parallel drive rods from a cavity fill position to a patty discharge position, the lubrication system comprising:
a plurality of bearings, at least one bearing journaling each drive rod, said bearings each having a lubrication oil channel therein;
a lubrication oil reservoir;
a conduit from said reservoir to said lubrication oil channels; and
a pump arranged to deliver oil from said reservoir through said conduit and through said channels to lubricate sliding movement of said rods through said bearings.

2. The lubrication system according to claim 1, wherein said apparatus comprises a frame for supporting said mold plate, and wherein said plurality of bearings comprises four bearings, two bearings being allocated to each drive rod, said two bearings located spaced-apart along the respective drive rod.

3. The lubrication system according to claim 2, comprising a return conduit from said channels to said reservoir, and further comprising a filter arranged in the flow path between said channels and said reservoir.

4. The lubrication system according to claim 1, wherein said bearings each comprise a sleeve, and said channel comprises a helical groove formed on an inside surface of said sleeve, between said sleeve and said drive rod.

5. A lubrication system for a patty-forming apparatus of the kind having a reciprocating mold plate driven from a cavity fill position to a patty discharge position, and two food product pumps alternatively operable to supply food product to the mold plate, said food product pumps being selected to communicate food product to the mold plate by a rotatable tube valve, the lubrication system comprising:
at least one tube valve bushing for journaling rotary movement of said tube valve, said tube valve bushing having a channel therein arranged for being filled with lubricating material.

6. The lubrication system according to claim 5, wherein said tube valve is fit within a manifold that directs food product from said food product pumps to said mold plate, and wherein said tube valve bushing is externally mounted to said manifold.

7. The lubrication system according to claim 5, wherein said tube valve is fit within a manifold that directs food product from said food product pumps to said mold plate, and wherein said at least one tube valve bushing comprises two tube valve bushings, each of said tube valve bushings having said channel therein arranged for being filled with lubricating material, and wherein said tube valve bushings journal opposite ends of said tube valve, said tube valve bushings mounted externally to opposite sides of said manifold.

8. The lubrication system according to claim 6, wherein said channel of each said tube valve bushing comprises a groove on an inside surface of said respective tube valve bushing, and each said tube valve bushing comprises a grease fitting exposed on an outside of said tube valve bushing and in communication with said groove.

9. The lubrication system according to claim 5, wherein said channel comprises a groove on an inside surface of said tube valve bushing, and comprising a grease fitting exposed on an outside of said tube valve bushing and in communication with said groove.

10. A lubrication system for a patty-forming apparatus of the kind having a reciprocating mold plate driven from a cavity fill position to a patty discharge position, and a knockout mechanism having knockout plungers that are reciprocal between a stand by position and a deployed position to displace patties from the mold plate, the knockout mechanism having a rotary member that converts rotation input to reciprocation of said knockout plungers, the lubrication system comprising:
a substantially sealed oil containing compartment surrounding said rotary member.

11. The lubrication system according to claim 10, wherein said rotary member comprises a hub having an eccentric connection, wherein said knockout mechanism comprises a knockout rod operatively connected to said eccentric connection, wherein said hub and said eccentric connection are contained within said oil containing compartment.

12. The lubrication system according to claim 11, wherein said knockout rod sealingly penetrates through said compartment to be operatively connected to said plungers.

13. The lubrication system according to claim 12, comprising a slide bearing mounted to said compartment and arranged to journal said knockout rod, said slide bearing comprising an inside channel and a fitting in communication with said inside channel for supplying lubricant between said slide bearing and said knockout rod.

14. The lubrication system according to claim 13, comprising a crank rod connected to said eccentric connection, and a frame connected to said crank rod and to said knockout rod, said frame located outside said compartment, said crank rod sealed for sliding and pivoting movement with respect to said compartment.

15. The lubrication system according to claim 13, comprising a pressurized lubricant delivery system, controlled to periodically deliver lubricant to said inside channel.

16. The lubrication system according to claim 10, wherein said rotary member includes a formation that act to sling oil within said compartment to upper areas of said compartment.

17. A lubrication system for a patty-forming apparatus of the kind having a reciprocating mold plate driven by parallel drive rods from a cavity fill position to a patty discharge position, and two food product pumps alternatively operable to supply food product to the mold plate, said food product pumps being selected to communicate food product to the mold plate by a rotatable tube valve, and a knockout mechanism having knockout plungers that are reciprocal between a stand by position and a deployed position to displace patties from the mold plate, the knockout mechanism having a rotary member that converts rotation input to reciprocation of said knockout plungers, the lubrication system comprising:
a plurality of bearings, at least one bearing journaling each drive rod, said bearings each having a lubrication oil channel therein;
a lubrication oil reservoir;
a conduit from said reservoir to said lubrication oil channels; and
a pump arranged to deliver oil from said reservoir through said conduit and through said channels to lubricate sliding movement of said rods through said bearings; and
a substantially sealed oil containing compartment surrounding said rotary member.

18. The lubrication system according to claim 17, further comprising at least one tube valve bushing, for journaling rotary movement of said tube valve, said tube valve bushing having a channel therein for being filled with lubricating material.

19. The lubrication system according to claim 18, wherein said rotary member comprises a hub having an eccentric connection, wherein said knockout mechanism comprises a knockout rod operatively connected to said eccentric connection, wherein said hub and said eccentric connection are contained within said oil containing compartment.

20. The lubrication system according to claim 19, wherein said knockout rod sealingly penetrates through said compartment.
